(19) United States
(12) Patent Application Publication
(10) Pub. No.: US 2002/0083250 A1
(43) Pub. Date: Jun. 27, 2002

(54) Apparatus and method for arbitrating use authority for system bus in a multi-stage connection

(76) Inventors: Do-Young Kim, Taejon (KR); Dae-Ung Kim, Taejon (KR)

Correspondence Address: JACOBSON, PRICE, HOLMAN & STERN, PROFESSIONAL LIMITED LIABILTY COMPANY, 400 Sevent Street, N.W., Washington, DC, 20004, US

(21) Appl. No.: 09/818,761

(22) Filed: Mar. 28, 2001

(30) Foreign Application Priority Data
Dec. 26, 2000 (KR) 2000-82200

(51) Int. Cl. G06F 12/00; G06F 13/14; G06F 13/38

(52) U.S. Cl. 710/240

(57) ABSTRACT

The present invention relates to apparatus and method for arbitrating use authority for system bus in a multi-stage connection; and, more particularly, to a bus arbiter to grant fair use authorities to service objects in consideration with priority orders between many units in a multi-stage connection required in large capacity systems. The cell bus arbiter according to the present invention comprises a filter for receiving a plurality of bus request signals from other cell bus arbiters and outputting unmasked request signals to an external circuit in response to information about bus use records of a specific service object; a selector for selecting one from unmasked request signals based on a priority thereof; a latch circuit for storing the selected signals by the selector; and a flag generator for classifying a service state which is provided for a service object and outputting the mask signal according to the classified service state, wherein the flag generator stops an activation of the mask signal in case where the service is terminated.

### FIELD OF INVENTION

The present invention relates to apparatus and method for arbitrating use authority for system bus in a multi-stage connection; and, more particularly, to a bus arbiter to grant fair use authorities to service objects in consideration with priority orders between many units in a multi-stage connection required in large capacity systems.

### DESCRIPTION OF THE PRIOR ARTS

Generally, there are provided some bus arbitration methods, such as the Daisy Chain using a VME bus of MOTOROLA Company, the Distributed Bus Arbitration and the Full Connected Bus Arbitration.

In the Daisy Chain, a plurality of objects connected to a common bus shares a bus request line and a use authority of a system bus is allowed by connecting a bus authority signal to the Daisy Chain.

In the Distributed Bus Arbitration, each object itself has a specific identification and such a specific identification is sent to an arbiter with a use request for the system bus. If there is an identification collision, the bus use authority is given to an object having an identification of a low value.

In the Full Connected Bus Arbitration, each object has a separate bus request signal and a signal line for a bus use and a use authority of the bus is controlled by various algorithms of the bus arbiter.

However, the Full Connected Bus Arbitration may not give a fair use authority between service objects when the objects requesting such a use authority frequently and excessively occupies the bus, because a simple First-in-First-out (FIFO) method is used in the bus use authority.

To solve the above problems, with respect to a constitution of the cell bus for a high-speed data transmission on an one-to-one or one-to-N(an arbitrary group) basis, studies for improving the simple FIFS (First-in-First-Serve) of the conventional bus arbiter and then for providing a fair bus arbitration service to a data processing system has been developed. Typically, such a study has been focused on an additional service flag with fundamental FIFS (First-in-First-Serve) for a plurality of objects transmitting/receiving data via a parallel bus.

However, in the large and ultra-large capacity systems, the conventional cell bus arbiters don't provide a multi-stage connection in which the systems are essentially required to process a few tens to hundreds of cell bus requests.

### SUMMARY OF THE INVENTION

It is, therefore, an object of the present invention to provide a bus arbiter to grant a fair use authority between large capacity units in a multi-stage connection which is essentially required to process a few tens to hundreds of cell bus requests in large and ultra-large capacity systems.

In accordance with an aspect of the present invention, there is provided a cell bus arbiter controlling data transmission and receipt between service objects connected to a common bus in a multi-stage connection, in which data include a predetermined size and target address, the cell bus arbiter comprising: a first means for receiving a plurality of bus request signals from other cell bus arbiters and outputting unmasked request signals to an external circuit in response to information about bus use records of a specific service object; a second means for selecting one from unmasked request signals based on a priority thereof; a third means for latching the selected signals by the second means; and a fourth means for classifying a service state which is provided for a service object and outputting the mask signal according to the classified service state, wherein the fourth means stops an activation of the mask signal in case where the service is terminated.

In accordance with another aspect of the present invention, there is provided a method for arbitrating a cell bus transmitting and receiving data between service objects connected to a common bus in a multi-stage connection, in which data include a predetermined size and target address, the method comprising the steps of: a) deciding if bus request signals are inputted from a plurality of service objects and if a control grant signal is activated; b) activating a valid bus request signal and decoding priorities of the inputted bus request signals; c) latching a bus request signal having the highest priority; d) outputting service flag information of a bus grant signal; and e) deciding if there is a valid bus request signal and, if so, repeating the steps a) to d) and, if not, releasing the service flag information.

In accordance with still another aspect of the present invention, there is provided a computer-readable medium storing a program for arbitrating a cell bus transmitting and receiving data between service objects connected to a common bus in a multi-stage connection, in which data include a predetermined size and target address, the computer-readable medium comprising the function of: a) deciding if bus request signals are inputted are inputted from a plurality of service objects and if a control grant signal is activated; b) activating a valid bus request signal and decoding priorities of the inputted bus request signals; c) latching a bus request signal having the highest priority; d) outputting service flag information of a bus grant signal; and e) deciding if there is a valid bus request signal and, if so, repeating the steps a) to d) and, if not, releasing the service flag information.

### BRIEF DESCRIPTION OF THE DRAWINGS

Other objects and aspects of the present invention will become apparent from the following description of the embodiments with reference to the accompanying drawings, in which:

FIG. 1 is a block diagram illustrating a multi-stage connection cell bus arbiter according to the present invention;

FIG. 2 is a block diagram illustrating a unit bus arbiter in the multi-stage connection cell bus arbiter of FIG. 1; and

FIG. 3 is a flow chart illustrating a method for arbitrating a cell bus in the multi-stage connection of FIG. 2.

### DETAILED DESCRIPTION OF THE INVENTION

Hereinafter, a cell bus arbiter according to the present invention will be described in detail referring to the accompanying drawings.

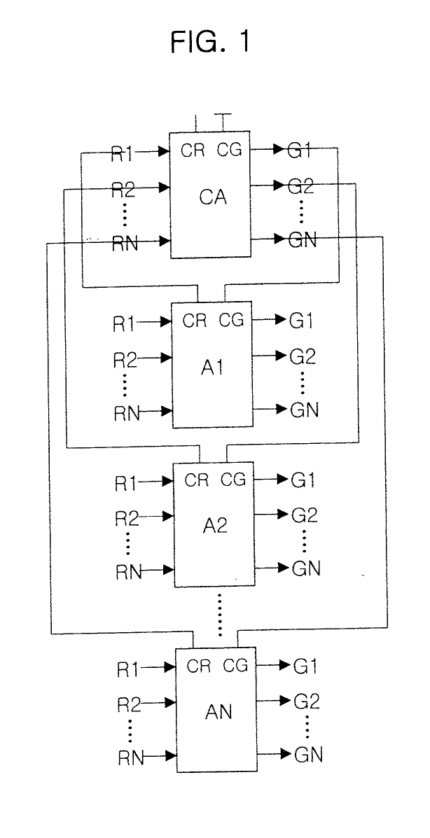

Referring to FIG. 1, a multi-stage connection cell bus arbiter according to the present invention includes a plurality of cell bus arbiters CA, A1 to AN and these cell bus arbiters A1 to AN, except for a cell bus arbiter CA in the highest level, are connected to each other in a multi-stage connection. The cell bus arbiters A1 to AN are coupled to the cell bus arbiter CA through control request signals CR and control grant signals CG in order to process N bus request signals.

N service objects are connected to a parallel bus of the cell bus arbiters CA and A1 to AN and competitively output bus request signals R1 to RN to each of the cell bus arbiters A1 to AN. A bus use for each request is authorized by the cell bus arbiters CA and A1 to AN and then the cell bus arbiters CA and A1 to AN output the control grant signals CG to the cell bus arbiters A1 to AN in order to implement the multi-stage connection cell bus arbiter according the present invention.

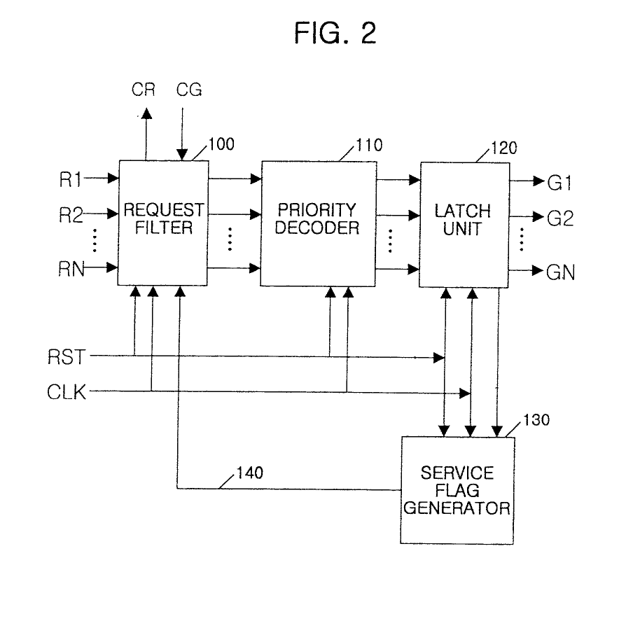

Referring to FIG. 2, each of the cell bus arbiters CA and A1 to AN includes a request filter 100 receiving the bus request signals R1 to RN, a priority decoder 110 coupled to the request filter 100, a latch unit 120 coupled to the priority decoder 110 and a service flag generator 130.

When one of the service objects has use a bus with a bus request and thereafter other service objects require the bus use before the previous request has been terminated, these service objects may use the bus according to their priorities. In case where there are no request from other objects, service records for the current object using the bus is erased and a priority is given to such a current object.

The operation of the multi-stage connection cell bus arbiter according to the present invention will be described in detail referring to FIGS. 2

First, after initializing all flip-flops, the request filter 100 decides if bus request signals R1 to RN from the plurality of service objects are issued. In the case where a bus request signal is issued, the request filter 100 receives such a bus request signal and outputs a control request signal CR by outputting only unmasked request signals using an N-bit service mask information 140.

The control request signal CR, which is an output of the request filter 100, is produced by carrying out summation of the bus request signals R1 to RN through logic gates and this may be activated when any one of the bus request signals R1 to RN is activated.

The request filter 100 decides if a control grant signal CG, which is input from the cell bus arbiters CA, is activated in order to allow the request signal to be granted and, in the case where the control grant signal CG is activated and a reset signal RST is not activated, the request filter 100 activates a valid bus request by detecting and processing the bus request signals R1 to RN when the bus is not used and a mask signal is not activated. At this time, the bus request signals R1 to RN are sampled at a falling edge of a clock signal and processed in each of the cell bus arbiters CA and A1 to AN.

The request filter 100 is normally operates only when the reset signal RST is not activated and, when the reset signal RST is activated, the outputs of the request filter 100 are not activated.

The control grant signal CG, which is produced by the cell bus arbiter.

For a multi-stage connection, the cell bus arbiters CA set the bus control request CR to be open and the control grant signal CG to be activated.

When the bus grant signals G1 to GN granting a requester to use the bus are terminated, the request filter 100 detects an active state and the request filter 100 receives from the service flag generator 130 a bus request information 140 notifying whether there is a bus request in order to decide if the service flag generator 130 has to maintain or delete the service records.

The priority decoder 110 receives one of the output signals from the request filter 100, which has the highest priority, and decodes and outputs the received signal. Typically, this can be implemented by a priority decoder logic circuit and this is well known to those skilled in the art to which the subject matter pertains.

The latch unit 120 latches the highest priority for a predetermined time in order to maintain the use authority for the system bus based on the highest priority and outputs the bus grant signals G1 to GN indicating that the system bus is now used. Also, the latch unit 120a keeps the bus grant signals G1 to GN activated via a counter therein during a clock cycle of a data transmission.

The request filter 100 decides if there are the bus request signals R1 to RN and releases the service flag in the case where there is no bus request signal.

The service flag generator 130 functions as a record maintaining unit to record the bus authority for a bus request signal form a specific service object and outputs the records to the request filter 100 in a form of service mask information 140. Also, after activating the bus grant signals G1 to GN through a counter, the service flag generator 130 negates the bus grant signals G1 to GN after counting predetermined clocks.

The request filter 100 decides which requests from the upper units are valid or not. If there exists a valid bus request signal, the request filter 100 repeats the forgoing procedures and, if not, it releases the service flag in the case where there is no valid bus request signal.

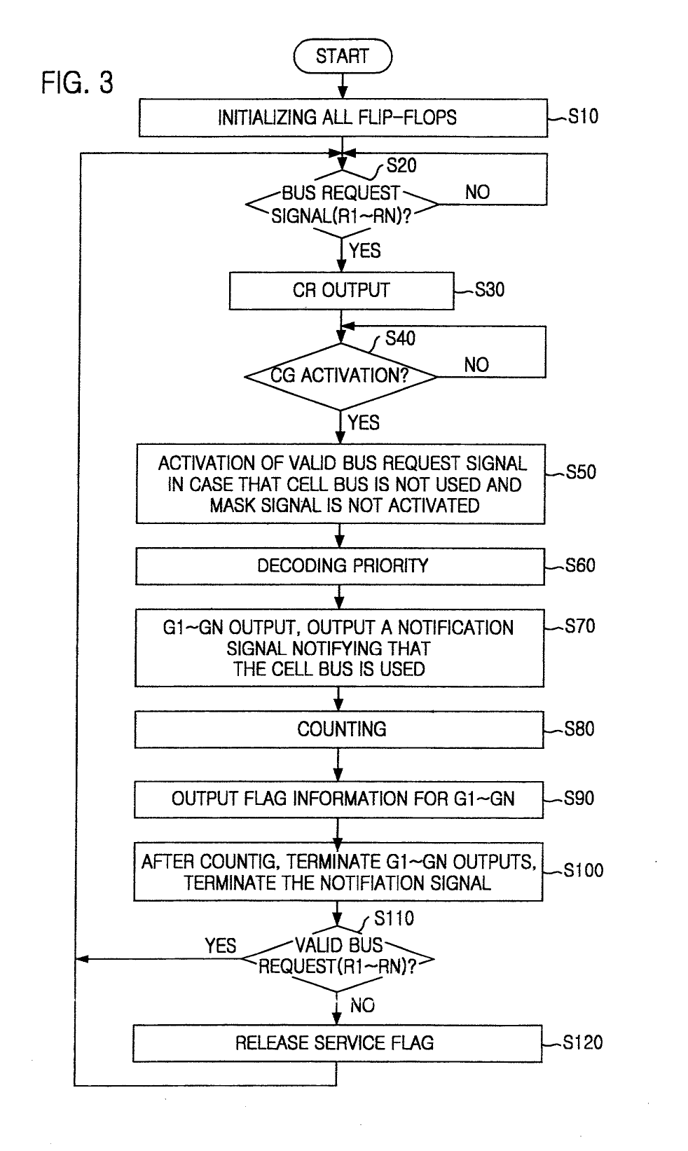

FIG. 3 is a flow chart illustrating a method for arbitrating cell bus in the multi-stage connection of FIG. 2.

First, all the flip-flops are initialized at step S10 and, at step S20, the request filter 100 decide if bus request signals R1 to RN from the plurality of service objects are issued. In the case where a bus request signal R1˜RN are issued, the request filter 100 outputs a control request signal CR at step S30 and it is decided if the control grant signal CG is activated or not at step S40. At step S50, when the bus is not used and a mask signal is not activated, the valid bus request is activated.

Subsequently, the request filter 100 decodes its priority at step S60, outputs the bus grant signals G1 to GN indicating that the system bus is now used, and operates the counter at step S80. At step S90, the service flag information for the bus grant signals G1 to GN is issued from the service flag generator 130 and the service flag generator 130 negates the bus grant signals G1 to GN after counting predetermined clocks at step S100. Also, the request filter 100 decides if there is a bus request signal at step S110. If there exists a the bus request signal, the request filter 100 repeats the forgoing steps and, if not, it releases the service flag in the case where there is no bus request signal at step S120.

The above-mentioned method for granting the fair use authority for the system bus-in accordance with the present invention can be stored in computer-readable media, such as CD-ROMS, RAMs, ROMs, floppy disks, hard disks and optical magnetic disks.

As apparent from the above-mentioned, the bus arbiter having the multi-stage connection according to the present invention can be acceptable to a bus use authority from the service objects using the FIFO method in a cell bus and can implement a fair service in frequent bus requests between the service objects by recoding the use of the system bus and providing the multi-stage connection. Accordingly, in a communication network on the basis of packet, such as an ATM network, or in a terminal, the bus arbiter having the multi-stage connection according to the present invention improves the quality of the communication service with a low delay for each required service.

Particularly, in the case where it is required that a separate priority is given to a specific service object, the present invention can give a bus authority to the specific service object N (N: integer) times as much as other service objects by building an excessive service request signal in the bus arbiter. Accordingly, the present invention can effectively adjust the bus authority in requiring large bus arbitration. Further, in a terminal or a service system, the present invention can effectively give a fair priority to a plurality of service modules having a plurality of data generating rates so that it is possible provides a multiplex for a few tens to a few hundreds of service objects.

What is claimed is:

1. A cell bus arbiter controlling data transmission and receipt between service objects connected to a common bus in a multi-stage connection, in which data include a predetermined size and target address, the cell bus arbiter comprising:
a first means for receiving a plurality of bus request signals from other cell bus arbiters and outputting unmasked request signals to an external circuit in response to information about bus use records of a specific service object;
a second means for selecting one from unmasked request signals based on a priority thereof;
a third means for latching the selected signals by the second means; and
a fourth means for classifying a service state which is provided for a service object and outputting the mask signal according to the classified service state, wherein the fourth means stops an activation of the mask signal in case where the service is terminated.

2. The cell bus arbiter as recited in claim 1, wherein the cell bus arbiter is connected to cell bus arbiters of other service objects by a control request signals and control grant signals.

3. The cell bus arbiter as recited in claim 1, wherein the first to fourth means are synchronized with a clock signal

4. The cell bus arbiter as recited in claim 1, wherein the first to fourth means are synchronized with a clock signal

5. A method for arbitrating a cell bus transmitting and receiving data between service objects connected to a common bus in a multi-stage connection, in which data include a predetermined size and target address, the method comprising the steps of:
a) deciding if bus request signals are inputted are inputted from a plurality of service objects and if a control grant signal is activated;
b) activating a valid bus request signal and decoding priorities of the inputted bus request signals;
c) latching a bus request signal having the highest priority;
d) outputting service flag information of a bus grant signal; and
e) deciding if there is a valid bus request signal and, if so, repeating the steps a) to d) and, if not, releasing the service flag information.

6. The method as recited in claim 5, wherein the step a) comprises the step of:
outputting the control request signal if there is the bus request signal.

7. The method as recited in claim 5, wherein the step b) comprises the step of:
activating the valid bus request signal in case where the cell bus is not used and the flag information signal is not activated signal.

8. The method as recited in claim 5, wherein the step d) comprises the steps of:
outputting the bus grant signal and a signal notifying that the cell bus is used; and
counting a time the cell bus is used.

9. A computer-readable medium storing a program for arbitrating a cell bus transmitting and receiving data between service objects connected to a common bus in a multi-stage connection, in which data include a predetermined size and target address, the computer-readable medium comprising the function of:
a) deciding if bus request signals are inputted are inputted from a plurality of service objects and if a control grant signal is activated;
b) activating a valid bus request signal and decoding priorities of the inputted bus request signals;
c) latching a bus request signal having the highest priority;
d) outputting service flag information of a bus grant signal; and
e) deciding if there is a valid bus request signal and, if so, repeating the steps a) to d) and, if not, releasing the service flag information.
